(19) United States
(12) Patent Application Publication
(10) Pub. No.: US 2006/0284560 A1
(43) Pub. Date: Dec. 21, 2006

(54) Cold cathode fluorescent lamp, method of manufacturing the same, and backlight assembly and display apparatus having the same

(75) Inventors: Jheen-Hyeok Park, Seongnam-si (KR); Jin-Sung Choi, Yongin-si (KR); Sang-Hyuck Yoon, Seoul (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/451,792

(22) Filed: Jun. 13, 2006

(30) Foreign Application Priority Data
Jun. 15, 2005 (KR) 2005-51525

(51) Int. Cl. H01J 1/62; H01J 61/30

(52) U.S. Cl. 313/634; 313/493

(57) ABSTRACT

A cold cathode fluorescent lamp includes a lamp tube, a fluorescent layer, an inner electrode, a lead wire and a conducting cap. The lamp tube contains a discharge gas. The fluorescent layer is formed on an inner surface of the lamp tube. The inner electrode is disposed inside of the lamp tube. The lead wire is electrically connected to the inner electrode and extends to an exterior portion of the lamp tube. The conducting cap is combined with the lamp tube, and electrically connected to the lead wire. As a result, a soldering process is not required. Further, a malfunction caused by an opening of a lamp wire is prevented.

### CROSS REFERENCE TO RELATED APPLICATION

This application claims priority from Korean Patent Application No. 2005-51525 filed on Jun. 15, 2005, the contents of which are herein incorporated by reference in their entirety.

### BACKGROUND OF THE INVENTION

1. Technical Field

The present disclosure relates to a cold cathode fluorescent lamp, a method of manufacturing the cold cathode fluorescent lamp, and a backlight assembly and a display apparatus having the cold cathode fluorescent lamp. More particularly, the present disclosure relates to a cold cathode fluorescent lamp capable of simplifying the assembling process thereof, and a backlight assembly and a display apparatus capable of driving the cold cathode fluorescent lamp in parallel.

2. Discussion of the Related Art

A liquid crystal display apparatus displays an image by using liquid crystal having an isotropy of refractivity and an isotropy of dielectric constant. A liquid crystal display apparatus is light, and has a low driving voltage in comparison with a cathode ray tube and a plasma display panel. The liquid crystal display apparatus is used in various applications.

The liquid crystal display apparatus includes a liquid crystal display panel having a thin film transistor (TFT) substrate, a color filter substrate facing the TFT substrate and a liquid crystal layer disposed between the TFT substrate and the color filter substrate. The liquid crystal display panel, which uses light in order to display an image, does not emit the light by itself. The liquid crystal display apparatus may include a backlight assembly that provides the liquid crystal display panel with light.

The backlight assembly may be classified as an edge illumination type or a direct illumination type according to a position of a cold cathode fluorescent lamp. In the edge illumination type backlight assembly, a cold cathode fluorescent lamp is disposed at a side of a light guide plate including a transparent material such as acryl, so that the edge illumination type backlight assembly is thin.

In the direct illumination type backlight assembly, a plurality of cold cathode fluorescent lamps is disposed under the liquid crystal display panel, so that the direct illumination type backlight assembly has a high luminance. Therefore, an apparatus that requires high luminance such as a television receiver set may employ the direct illumination type liquid crystal display apparatus.

The cold cathode fluorescent lamp employed by the backlight assembly includes an electrode disposed in a lamp tube. As a result, the cold cathode fluorescent lamp requires a lead wire for connecting the electrode to a power source disposed outside of the lamp tube. A lamp wire, electrically connected to an inverter that generates a driving voltage, is electrically connected to the lead wire.

As a size of the backlight assembly increases, a number of cold cathode fluorescent lamps employed by the backlight assembly increases, thereby complicating an assembly process. Further, a connection of wires may be easily broken.

### SUMMARY OF THE INVENTION

Embodiments of the present invention provide a cold cathode fluorescent lamp capable of simplifying assembly, a method of manufacturing the cold cathode fluorescent lamp, a backlight assembly having the cold cathode fluorescent lamp, and a display apparatus having the cold cathode fluorescent lamp.

A cold cathode fluorescent lamp according to an embodiment of the present invention includes a lamp tube, a fluorescent layer, an inner electrode, a lead wire and a conducting cap. The lamp tube contains a discharge gas. The fluorescent layer is formed on an inner surface of the lamp tube. The inner electrode is disposed inside of the lamp tube. The lead wire is electrically connected to the inner electrode and extends to an exterior portion of the lamp tube. The conducting cap is combined with the lamp tube, and is electrically connected to the lead wire.

In a method of manufacturing a cold cathode fluorescent lamp, according to an embodiment of the present invention, a lamp tube is formed. A fluorescent layer is formed on an inner surface of the lamp tube. An inner electrode is disposed inside of the lamp tube, and is electrically connected to a lead wire. A portion of the lead wire is disposed outside of the lamp tube. Discharge gas is injected into the lamp tube. The lamp tube is sealed, and then, a conducting cap is combined with the lamp tube such that the conducting cap is electrically connected to the lead wire.

A backlight assembly, according to an embodiment of the present invention, includes a receiving container, a fixing member and a plurality of cold cathode fluorescent lamps. The fixing member is disposed at a side portion of the receiving container, the fixing member being electrically conductive. The plurality of cold cathode fluorescent lamps is combined with the fixing member and the lamps are positioned substantially in parallel with each other. Each of the cold cathode fluorescent lamp includes a lamp tube, a fluorescent layer, an inner electrode, a lead wire and a conducting cap. The lamp tube contains a discharge gas. The fluorescent layer is formed on an inner surface of the lamp tube. The inner electrode is disposed inside of the lamp tube. The lead wire is electrically connected to the inner electrode and extends to an exterior portion of the lamp tube. The conducting cap is combined with the lamp tube, and electrically connected to the lead wire.

A display apparatus, according to an embodiment of the present invention, includes a backlight assembly and a display unit. The backlight assembly includes a receiving container, a fixing member and a plurality of cold cathode fluorescent lamps. The fixing member is disposed at side portion of the receiving container, the fixing member being electrically conductive. The plurality of cold cathode fluorescent lamps is combined with the fixing member, and the lamps are positioned substantially in parallel with each other. Each of the cold cathode fluorescent lamps includes a lamp tube, a fluorescent layer, an inner electrode, a lead wire and a conducting cap. The lamp tube contains a discharge gas. The fluorescent layer is formed on an inner surface of the lamp tube. The inner electrode is disposed inside of the lamp tube. The lead wire is electrically connected to the inner electrode and extends to an exterior portion of the lamp tube. The conducting cap is combined with the lamp tube, and electrically connected to the lead wire. The display unit displays an image by using a light provided by the backlight assembly.

According to an embodiment of the present invention, the conducting cap is formed at the end portion of the lamp tube, such that the conducting cap is electrically connected to the lead wire. As a result, a soldering process is not required. Further, a malfunction caused by an opening of a lamp wire is prevented.

Furthermore, assembly is facilitated by inserting the conducting cap into the clip portion of the fixing member to combine the cold cathode fluorescent lamp with the inverter that provides the cold cathode fluorescent lamp with electric power.

Additionally, a plurality of the cold cathode fluorescent lamps is connected in parallel through the connecting portion, so that the cold cathode fluorescent lamps may be driven in parallel. Therefore, a number of inverters may be reduced, and manufacturing costs may be lowered.

### BRIEF DESCRIPTION OF THE DRAWINGS

Exemplary embodiments of the present invention can be understood in more detail from the following descriptions taken in conjunction with the accompanying drawings, in which:

FIG. 1 is a perspective view illustrating a cold cathode fluorescent lamp according to an exemplary embodiment of the present invention;

FIG. 2 is a cross-sectional view taken along a line I-I′ in FIG. 1;

FIG. 3 is an exploded perspective view illustrating a backlight assembly according to an exemplary embodiment of the present invention;

FIG. 4 is a perspective view illustrating a combination of a fixing member and a cold cathode fluorescent lamp according to an exemplary embodiment of the present invention;

FIG. 5 is perspective view illustrating a combination of a fixing member and a cold cathode fluorescent lamp according to another exemplary embodiment of the present invention;

FIG. 6 is a perspective view illustrating a backside of a second side mold according to an exemplary embodiment of the present invention; and

FIG. 7 is an exploded perspective view illustrating a liquid crystal display apparatus according to an exemplary embodiment of the present invention.

### DETAILED DESCRIPTION OF THE EXEMPLARY EMBODIMENTS

Exemplary embodiments of the present invention will now be described more fully hereinafter below in more detail with reference to the accompanying drawings. This invention may, however, be embodied in different forms and should not be construed as limited to the embodiments set forth herein.

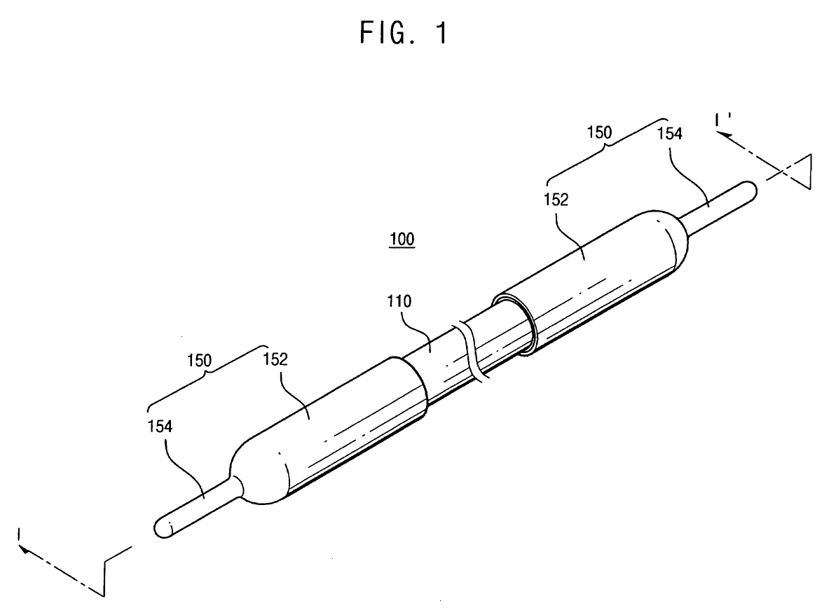

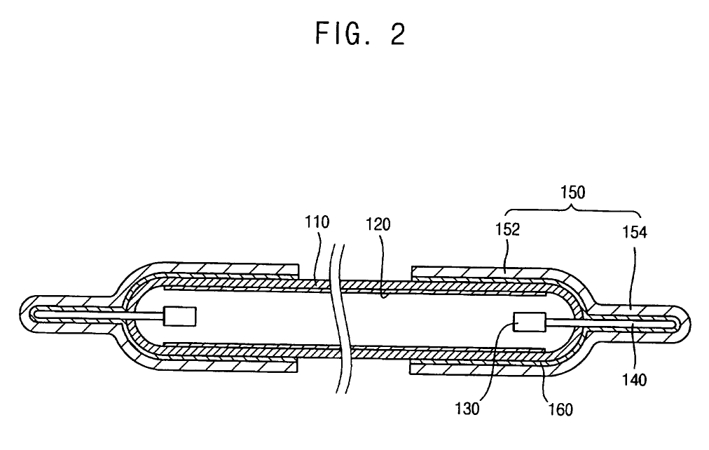

FIG. 1 is a perspective view illustrating a cold cathode fluorescent lamp according to an exemplary embodiment of the present invention, and FIG. 2 is a cross-sectional view taken along a line I-I′ in FIG. 1.

Referring to FIGS. 1 and 2, a cold cathode fluorescent lamp 100 includes a lamp tube 110, a fluorescent layer 120, an inner electrode 130, a lead wire 140 and a conducting cap 150.

The lamp tube 110 includes an optically transparent material, so that light may pass through the lamp tube 110. Discharge gas for generating light is injected into the lamp tube 110. For example, the discharge gas includes mercury (Hg), a mixture of neon (Ne), or argon (Ar).

The lamp tube 110 has, for example, a straight cylindrical shape having a short diameter. Alternatively, the lamp tube 110 may have, for example, an L-shape, or a U-shape.

The fluorescent layer 120 is disposed on an inner surface of the lamp tube 110. The fluorescent layer 120 converts ultraviolet light generated from the discharge gas into visible light.

The inner electrode 130 is disposed at an end portion of the lamp tube 110. The inner electrode 130 includes a metal having a relatively low work function, for example, such as nickel (Ni), molybdenum (Mo), or niobium (Nb).

The lead wire 140 has a first end portion that is electrically connected to the inner electrode 130 and a second end portion that is disposed outside of the lamp tube 110.

The conducting cap 150 is combined with an end portion of the lamp tube 110. The conducting cap 150 receives the end portion of the lamp tube 110. The conducting cap 150 is electrically connected to the lead wire 140. The conducting cap 150 includes a material having a high electric conductance. For example, the conducting cap 150 includes a metal or a metal alloy. For example, the conducting cap 150 includes, copper (Cu), or gold (Ag). The conducting cap 150 has a shape corresponding to the lamp tube 110 and the lead wire 140 in order to receive the lamp tube 110 and the lead wire 140. Particularly, the conducting cap 150 includes a first cap portion 152 covering the lamp tube 110, and a second cap portion 154 covering the lead wire 140. The first cap portion 152 has an inner diameter corresponding to an outer diameter of the lamp tube 110, and the second cap portion 154 has an inner diameter corresponding to an outer diameter of the lead wire 140. The diameter of the second cap portion 154 is smaller than the diameter of the first cap portion 152.

An electrically conductive adhesive 160 may be disposed between the lead wire 140 and the conducting cap 150. The electrically conductive adhesive 160 may also be disposed between the lamp tube 110 and the conducting cap 150. The conductive adhesive fastens the conducting cap 150 to the lamp tube 110 and electrically connects the conducting cap 150 to the lead wire 140.

The conductive adhesive 160 includes conductive particles in order to electrically connect the lead wire 140 and the conducting cap 150. For example, a silver (Ag) paste including silver (Ag) particles may be employed as the conductive adhesive 160.

The cold cathode fluorescent lamp 100 may further include a protection layer (not shown) disposed between an inner surface of the lamp body 110 and the fluorescent layer 120. The protection layer prevents chemical reaction between mercury (Hg) in the discharge gas and the lamp body including glass. Therefore, lamp body blackening and mercury loss are prevented.

When a driving voltage is applied to the cold cathode fluorescent lamp 100, the lamp generates light.

The driving voltage applied to the conducting cap 150 is applied to the inner electrode 130 through the lead wire 140. When the driving voltage is applied to the lead wire 140, electrons are emitted from the lead wire 140. The electrons emitted from the lead wire 140 collide with molecules of the discharge gas to ionize the discharge gas to generate plasma. When the plasma in an excited state of high energy is restored to be in a stable state of low energy, ultraviolet light is generated. The fluorescent layer 120 formed on the inner surface of the lamp tube 110 converts the ultraviolet light into visible light that is used for a display device.

Hereinafter, a method of manufacturing the cold cathode fluorescent lamp 100 will be explained.

The lamp tube 110 is formed, and then the fluorescent layer 110 is formed on the inner surface of the lamp tube 110.

The inner electrode 130 electrically connected to the lead wire 140 is disposed inside an end portion of the lamp tube.

The discharge gas is injected into the lamp tube 110 in a vacuum chamber, and the end portion of the lamp tube 110 is sealed such that the lead wire 140 is extracted from the inside of the lamp tube to be disposed outside of the lamp tube 110. A portion of the lead wire 140 is disposed inside of the lamp tube 110, and a remaining portion of the lead wire 140 is disposed outside of the lamp tube 110. Alternatively, the discharge gas may be injected before disposing the inner electrode 130 inside the lamp tube 110.

Then, the conducting cap 150 is combined with the lamp tube 110, such that the conducting cap 150 is electrically connected to the lead wire 140. The conducting cap 150 is shaped for receiving the end portion of the lamp tube 110. In other words, the conducting cap 150 has a shape corresponding to the lamp tube 110 and the lead wire 140.

The conducting cap 150 includes a first cap portion 152 covering the lamp tube 110, and a second cap portion 154 covering the lead wire 140. The first cap portion 152 has an inner diameter corresponding to an outer diameter of the lamp tube 110, and the second cap portion 154 has an inner diameter corresponding to an outer diameter of the lead wire 140. The diameter of the second cap portion 154 is smaller than the diameter of the first cap portion 152.

The method of manufacturing the cold cathode fluorescent lamp 100 may further include a process of disposing the conductive adhesive 160 between the lead wire 140 and the conducting cap 150. The conductive adhesive 160 may be pasted on an outer surface of the lamp tube 110, or the conductive adhesive 160 may be pasted on an inner surface of the conducting cap 150, before combining the conducting cap 150 with the lamp tube 110.

As a result, the conductive adhesive 160 is disposed between the lead wire 140 and the conducting cap 150. The conductive adhesive 160 may be disposed not only between the lead wire 140 and the conducting cap 150, but also between the lamp tube 110 and the conducting cap 150.

The electrically conductive adhesive 160 fastens the conducting cap 150 to the lamp tube 110. Additionally, the electrically conductive adhesive 160 enhances reliability of an electrical connection between the lead wire 140 and the conducting cap 150. Examples of the electrically conductive adhesive 160 include, for example, a silver (Ag) paste including silver (Ag) particles.

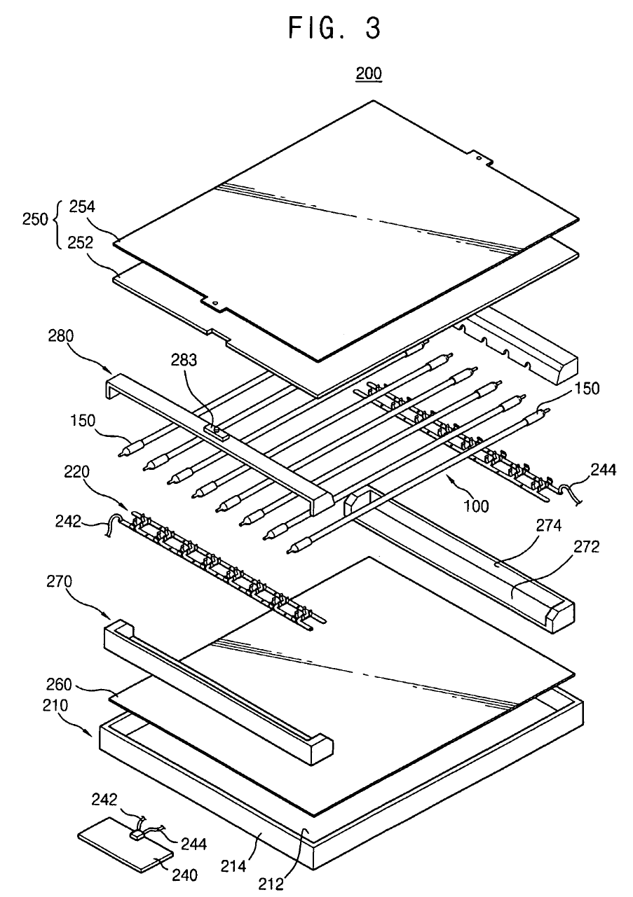

FIG. 3 is an exploded perspective view illustrating a backlight assembly according to an exemplary embodiment of the present invention. The backlight assembly includes the cold cathode fluorescent lamp shown in FIGS. 1 and 2.

Referring to FIG. 3, a backlight assembly 200 according to an exemplary embodiment of the present invention includes a receiving container 210, a fixing member 220 and a cold cathode fluorescent lamp 100.

The receiving container 210 includes a bottom portion 212 and a side portion 214 upwardly extended from edges of the bottom portion 212. The receiving container 210 includes high strength and deformation-resistance. For example, the receiving container 210 includes a metal.

The fixing member 220 is disposed at a side portion of the receiving container 210. The fixing member 220 fixes a plurality of cold cathode fluorescent lamps 100. The fixing member 220 includes a metal to apply an electrical power provided from an inverter 240 to the cold cathode fluorescent lamps 100.

The cold cathode fluorescent lamps 100 fixed to the fixing member 200 are arranged substantially in parallel with each other. The conducting cap 150 of each cold cathode fluorescent lamp 100 is combined with the fixing member 220. When a driving voltage generated by the inverter 240 is applied to the conducting cap 150 through the fixing member 220, light is generated from the cold cathode fluorescent lamp 100.

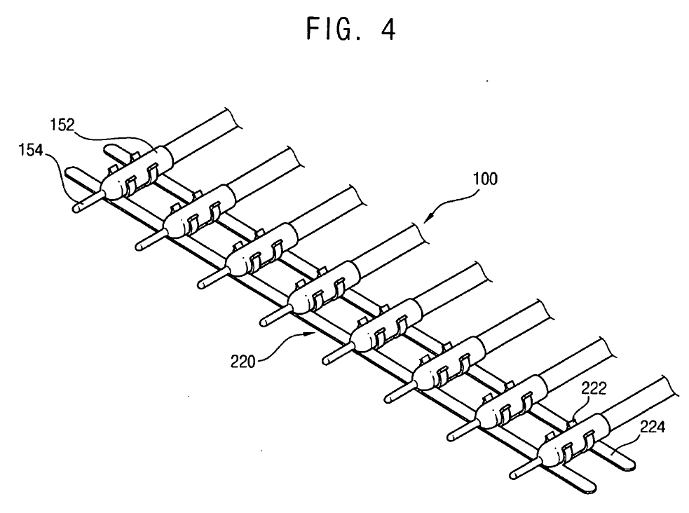

FIG. 4 is a perspective view illustrating a combination of a fixing member and a cold cathode fluorescent lamp shown in FIG. 3.

Referring to FIG. 4, the fixing member 220 includes a plurality of clip portions 222 and a connecting portion 224. Each of the clip portions 222 grips the conducting cap 150 of the cold cathode fluorescent lamp 100. The connecting portion 224 combines the clip portions 222.

Each of the clip portions 222 is upwardly protruded from the connecting portion 224 such that each of the clip portions 222 grips a cold cathode fluorescent lamp 100. Each of the clip portions 222 has an opening portion. The opening portion is disposed at upper portion of each of the clip portions 222. Each of the clip portions 222 has an arch shape corresponding to the outer face of the conducting cap 150. The cold cathode fluorescent lamp 100 may be inserted along a longitudinal direction through the opening portion.

The clip portions 222 are disposed and spaced apart from one another by a uniform interval in order to arrange the cold cathode fluorescent lamps 100 with the uniform interval. Alternatively, the clip portions 222 may be disposed and spaced apart from one another by non-uniform interval in order to arrange the cold cathode fluorescent lamps 100 with the non-uniform interval.

The connecting portion 224 is extended along a direction that is substantially perpendicular to a longitudinal direction of the cold cathode fluorescent lamp 100. The connecting portion 224 connects the clip portions 222 with each other.

The conducting cap 150 fixed to one of the clip portions 222 includes the first cap portion 152 covering the outer face of the lamp tube 110, and the second cap portion 154 covering the lead wire 140 as shown in FIG. 2. According to the present embodiment, the first cap portion 152 is combined with the clip portion 222.

As described above, by inserting the conducting cap 150 of the cold cathode fluorescent lamp 100 into the clip portion 222 and fixing the cold cathode fluorescent lamp 100 to the clip potion 222, assembly of the backlight assembly 200 is facilitated. Additionally, the clip portions 222 combined with cold cathode fluorescent lamps 100 are combined with each other through the connecting portion 224, so that the cold cathode fluorescent lamps 100 may be driven in parallel.

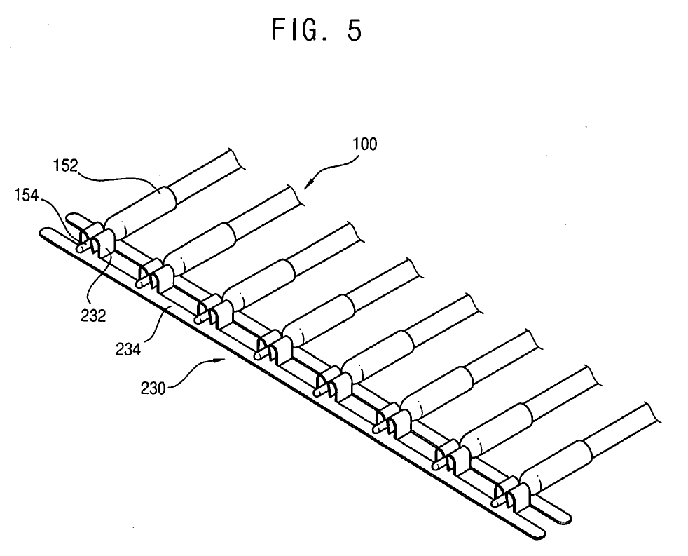

FIG. 5 is perspective view illustrating a combination of a fixing member and a cold cathode fluorescent lamp according to another exemplary embodiment of the present invention.

Referring to FIG. 5, a fixing member 230 includes a plurality of clip portions 232 and a connecting portion 234. Each of the clip portions 232 grips the conducting cap 150, and the connecting portion 234 combines the clip portions 232 with each other.

Each of the clip portions 232 is upwardly protruded from the connecting portion 234 such that the cold cathode fluorescent lamp 100 may be combined with the clip portions 232. Each of the clip portions 232 is curved to form a U-shape. In addition, each of the clip portions 232 has elasticity. In Two U-shaped clip portions 232 push toward each other, and the second cap portion 154 of the conducting cap 150 is inserted between the two U-shaped clip portions 232, so that the conducting cap 150 is combined with the clip portions 232.

The clip portions 232 are disposed and spaced apart from one another by a uniform interval in order to arrange the cold cathode fluorescent lamps 100 with the uniform interval. Alternatively, the clip portions 232 may be disposed and spaced apart from one another by non-uniform interval in order to arrange the cold cathode fluorescent lamps 100 with the non-uniform interval.

The connecting portion 234 is extended along a direction that is substantially perpendicular to a longitudinal direction of the cold cathode fluorescent lamp 100. The connecting portion 234 connects the clip portions 232 with each other.

The conducting cap 150 fixed to one of the clip portions 232 includes the first cap portion 152 covering the outer face of the lamp tube 110, and the second cap portion 154 covering the lead wire 140 as shown in FIG. 2. According to the present embodiment, the second cap portion 154 is combined with the clip portion 232.

As described above, by inserting the conducting cap 150 of the cold cathode fluorescent lamp 100 into the clip portion 232, and fixing the cold cathode fluorescent lamp 100 to the clip potion 232, assembly of the backlight assembly 200 is facilitated. Additionally, the clip portions 232 combined with cold cathode fluorescent lamps 100 are combined with each other through the connecting portion 234, so that the cold cathode fluorescent lamps 100 may be driven in parallel.

In order to prevent the cold cathode fluorescent lamp 100 from drifting from the clip portions 232, the fixing member 230 optionally includes a separation-preventing member (not shown).

Referring again to FIG. 3, a backlight assembly 200 may further include the inverter 240 and optical member 250. The inverter 240 generates a driving voltage for driving the cold cathode fluorescent lamps 100. The optical member 250 is disposed over the cold cathode fluorescent lamps 100.

The inverter 240 is disposed on a side of the receiving container 210, for example, a backside thereof. The inverter 240 converts a low level external alternating voltage to a high level driving voltage that is adequate for the cold cathode fluorescent lamps 100.

The inverter 240 is electrically connected to the fixing member 220 through a first power line 242 and a second power line 244. The driving voltage generated by the inverter 240 is applied to the conducting cap 150 through the first and second power lines 242 and 244, and the fixing member 220 (or 230). Therefore, the inverter 240 drives the cold cathode fluorescent lamps 100 connected electrically in parallel with each other through the fixing member 220 (or 230).

The optical member 250 is disposed over the cold cathode fluorescent lamps 100 to enhance optical properties of light generated from the cold cathode fluorescent lamps 100. The optical member 250 includes a light diffusing plate 252 for diffusing light and at least one optical sheet 254 for enhancing luminance.

The light diffusing plate 252 diffuses light generated by the cold cathode fluorescent lamps 100 to enhance luminance uniformity. The light diffusing plate 252 has a rectangular plate shape. The light diffusing plate 252 is supported by the second side mold 280 such that the light diffusing plate 252 is uniformly spaced apart from the cold cathode fluorescent lamps 100.

The light diffusing plate 252 includes, for example, polymethylmethacrylate (PMMA). Additionally, the light diffusing plate 252 may include a light-diffusing agent for diffusing light.

The optical sheet 254 is disposed over the light diffusing plate 252. The optical sheet 254 adjusts a path of light diffused by the light diffusing plate 252. The optical sheet 254 includes, for example, a prism sheet condensing light that is diffused by the light diffusing plate 252, so that a front-view luminance is enhanced. Additionally, the optical sheet 254 may include a light-diffusing sheet that further diffuses the light that is diffused by the light diffusing plate 252 to enhance luminance uniformity. Additionally, the optical sheet 254 may include a reflective polarizing sheet that reflects a portion of the light and polarizes a remaining portion of the light to enhance luminance. The backlight assembly 200 may include various kinds of optical sheets according to required properties.

The backlight assembly 200 may further include a light reflecting plate 260 disposed under the cold cathode fluorescent lamps 100. The light reflecting plate 260 is disposed on the bottom portion 212 of the receiving container 210. The light reflecting plate 260 reflects light generated by the cold cathode fluorescent lamps 100 toward the light diffusing plate 252 to enhance light using efficiency. The light reflecting plate 260 includes material having a high reflectivity. The light reflecting plate 260 includes, for example, a polyethyleneterephthalate (PET), or polycarbonate (PC). When the bottom portion 212 of the receiving container 210 includes material having a high reflectivity, the bottom plate 212 may operate as the light reflecting plate 260, such that the light reflecting plate 260 can be omitted.

The backlight assembly 200 may further include a first side mold 270 disposed between the receiving container 210 and the fixing member 220 (or 230) to fasten the fixing member 220 to the receiving container 210, and a second side mold 280 covering the conducting cap 150.

The first side mold 270 is disposed at a side portion of the receiving container 210, where the end portion of the cold cathode fluorescent lamps 100 is disposed. The first side mold 270 includes a combining portion 272 and a sidewall portion 274. The fixing member 220 is combined with the combining portion 272. The sidewall portion 274 is upwardly protruded from edge portions of the combining portion 272. The combining portion 272 corresponds to the bottom portion 212 of the receiving container 210, and the sidewall portion 274 corresponds to the side portion 214 of the receiving container 210. The first side mold 270 includes a dielectric material for electrically insulating the receiving container 210. The receiving container 210 includes a metal from the fixing member 220 that is electrically conductive.

The second side mold 280 covers the conducting caps 150 of the cold cathode fluorescent lamps 100, so that light is not emitted from the conducting caps 150. As a result, a dark region is removed and luminance uniformity is enhanced. Additionally, the second side mold 280 guides a position of the optical member 250 and supports the optical member 250 that is disposed on the second side mold 280. The second side mold 280 may further include a guide portion 283 for guiding the position of the optical member 250.

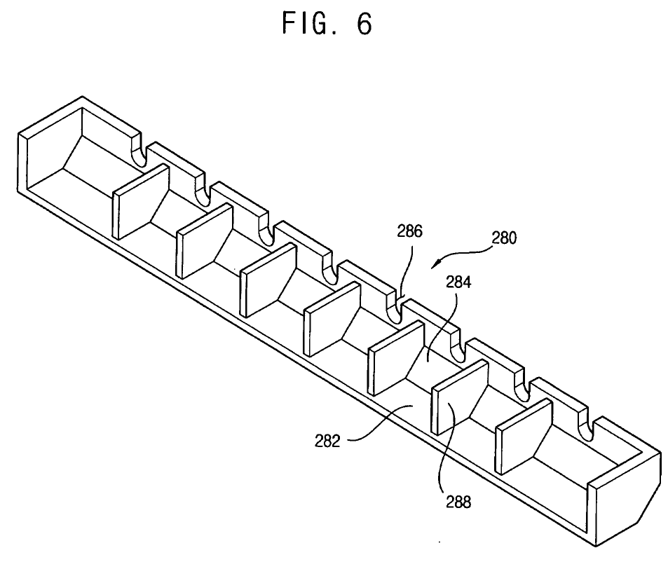

FIG. 6 is a perspective view illustrating a backside of a second side mold shown in FIG. 3.

Referring to FIGS. 3 and 6, the second side mold 280 includes an upper plate 282 and a reflective plate 284. The upper plate 282 is substantially in parallel with the bottom plate 212 of the receiving container 210. The reflective plate 284 is extended toward the bottom plate 212 of the receiving container 210 from the upper plate 282. The reflective plate 284 includes a plurality of openings 286. Each of the openings 286 receives a cold cathode fluorescent lamp 100.

The second side mold 280 optionally includes a partition member 288. The partition member 288 is extended from the upper plate 282 toward the fixing member 220 (or 230). The partition member 288 is disposed between the cold cathode fluorescent lamps 100 or between the clip portions 222 of the fixing member 220.

The partition member 288 compresses the connection portion 224 of the fixing member 220 to prevent moving or floating of the fixing member 220. Additionally, the partition member 288 is disposed between the cold cathode fluorescent lamps 100 to prevent interference between the cold cathode fluorescent lamps 100.

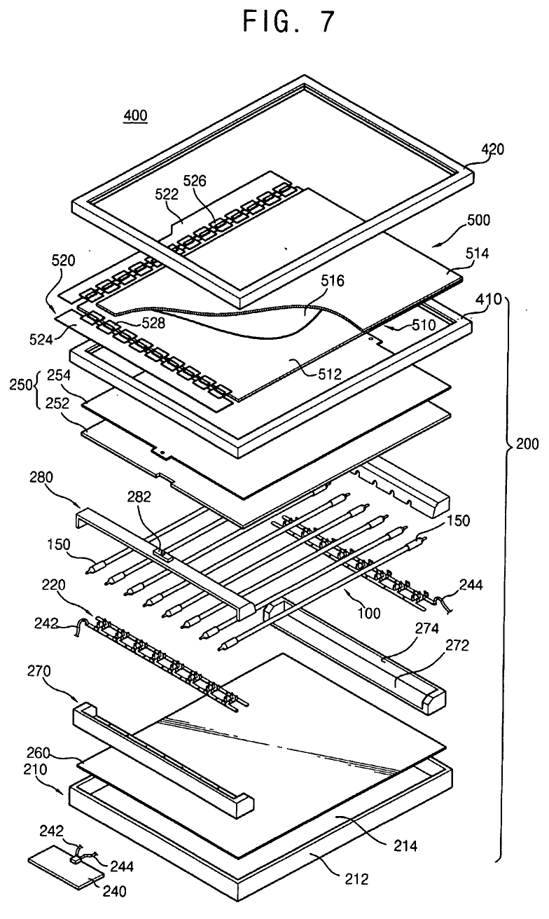

FIG. 7 is an exploded perspective view illustrating a liquid crystal display apparatus according to an exemplary embodiment of the present invention.

Referring to FIG. 7, a liquid crystal display apparatus 400 includes a backlight assembly 200 and a display unit 500. The backlight assembly 200 provides the display unit 500 with light. The display unit 500 displays an image by using the light provided by the backlight assembly 200. The backlight assembly 200 of the present embodiment is substantially the same as the backlight assembly described in connection with FIG. 3, except for the addition of a middle mold 410.

The middle mold 410 is combined with the receiving container 210 to fix the optical member 250. More specifically, the middle mold 410 is combined with the side portion 214 of the receiving container 210 while fixing edge portions of the optical member 250. The middle mold 410 also guides a position of the liquid crystal display panel 510 disposed on the middle mold 410. As a size of the middle mold 410 increases, the middle mold 410 may be formed in two or more pieces, such as, for example, four pieces.

The display unit 500 includes a liquid crystal display panel 510 and a driving circuit section 520. The liquid crystal display panel 510 is disposed over the backlight assembly 200. The liquid crystal display panel 510 displays an image by using light that is generated by the backlight assembly 200. The driving circuit section 520 drives the liquid crystal display panel 510.

The liquid crystal display panel 510 includes a first substrate 512, a second substrate 514 and a liquid crystal layer 516. The first and second substrates 512 and 514 face each other. The liquid crystal layer 516 is disposed between the first and second substrates 512 and 514.

The first substrate 512 includes a first transparent substrate and a plurality of switching devices arranged in a matrix shape on the first transparent substrate. Thin film transistors may be employed as the switching devices, and a glass substrate may be employed as the first transparent substrate. Each of the thin film transistors includes a gate electrode that is electrically connected to one of a plurality of gate lines, a source electrode that is electrically connected to one of a plurality of source lines, and a drain electrode that is electrically connected to one of a plurality of pixel electrodes. The pixel electrode includes an optically transparent and electrically conductive material such as, for example, indium tin oxide (ITO), or indium zinc oxide (IZO).

The second substrate 514 includes a second transparent substrate, color filters and a common electrode. A glass substrate may be employed as the second transparent substrate. The color filters are formed on the second transparent substrate. The common electrode is formed on the color filters. The common electrode includes an optically transparent and electrically conductive material such as, for example, indium tin oxide (ITO), or indium zinc oxide (IZO).

When the thin film transistor is turned on, electric fields are generated between the pixel electrodes of the first substrate 512 and the common electrode of the second substrate 514. When the electric fields are generated between the pixel electrodes of the first substrate 512 and the common electrode of the second substrate 514, an arrangement of liquid crystal molecules of the liquid crystal layer disposed between the pixel electrodes and the common electrode is altered to change an optical transmissivity. Therefore, an image is displayed.

The driving circuit section 520 includes a data printed circuit board 522, a gate printed circuit board 524, a data driving circuit film 526 and a gate driving circuit film 528. The data printed circuit board 522 provides the liquid crystal display panel 510 with data driving signals. The gate printed circuit board 524 provides the liquid crystal display panel 510 with gate driving signals. The data driving circuit film 526 connects the data printed circuit board 522 with the liquid crystal display panel 510. The gate driving circuit film 528 connects the gate printed circuit board 524 with the liquid crystal display panel 510.

The data driving circuit film 526 and the gate driving circuit film 528 may be embodied through, for example, a tape carrier package or a chip on film. Alternatively, when an additional signal wiring is formed at the liquid crystal display panel 510 and the gate driving circuit film 528, the driving circuit section 520 does not require the gate printed circuit board 524.

The liquid crystal display apparatus 400 may further include a top chassis 420 for fixing the display unit 500. The top chassis 420 is combined with the receiving container 210 to fix edge portions of the liquid crystal display panel 510. When the top chassis 420 is combined with the receiving container 210, the data printed circuit board 522 is bent such that the data printed circuit board 522 is disposed at the side portion 214 or the bottom portion 212 of the receiving container 210. The top chassis 420 includes, for example, a metal having high strength.

According to an embodiment of the present invention, the conducting cap is formed at the end portion of the lamp tube, such that the conducting cap is electrically connected to the lead wire. Therefore, a soldering process is not required. Furthermore, a malfunction caused by an opening of lamp wire is prevented.

Additionally, assembly is facilitated by inserting the conducting cap into the clip portion of the fixing member to combine the cold cathode fluorescent lamp with the inverter that provides the cold cathode fluorescent lamp with electric power.

Additionally, a plurality of the cold cathode fluorescent lamps is connected in parallel through the connecting portion, so that the cold cathode fluorescent lamps may be driven in parallel. Therefore, a number of inverters may be reduced to lower manufacturing cost.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. A cold cathode fluorescent lamp comprising:
a lamp tube containing a discharge gas;
a fluorescent layer formed on an inner surface of the lamp tube;
an inner electrode disposed inside the lamp tube;
a lead wire electrically connected to the inner electrode and extending to an exterior portion of the lamp tube; and
a conducting cap combined with the lamp tube, and electrically connected to the lead wire.

2. The cold cathode fluorescent lamp of claim 1, wherein the conducting cap has a first diameter and a second diameter that is different from the first diameter.

3. The cold cathode fluorescent lamp of claim 2, wherein the conducting cap comprises:
a first cap portion covering an outer surface of the lamp tube, the first cap portion having the first diameter; and
a second cap portion covering an outer surface of the lead wire, the second cap portion having the second diameter.

4. The cold cathode fluorescent lamp of claim 1, wherein the conducting cap comprises a metal or a metal alloy.

5. The cold cathode fluorescent lamp of claim 1, further comprising an electrically conductive adhesive between the lead wire and the conducting cap.

6. The cold cathode fluorescent lamp of claim 5, wherein the electrically conductive adhesive includes a silver paste.

7. A method of manufacturing a cold cathode fluorescent lamp, comprising:
forming a lamp tube;
forming a fluorescent layer on an inner surface of the lamp tube;
disposing an inner electrode inside of the lamp tube, wherein the inner electrode is electrically connected to a lead wire and a portion of the lead wire is disposed outside of the lamp tube;
injecting a discharge gas into the lamp tube;
sealing the lamp tube; and
combining a conducting cap with the lamp tube such that the conducting cap is electrically connected to the lead wire.

8. The method of claim 7, wherein the conducting cap comprises:
a first cap portion covering an outer surface of the lamp tube; and
a second cap portion covering an outer surface of the lead wire.

9. The method of claim 7, further comprising positioning an electrically conductive adhesive between the lead wire and the conducting cap.

10. A backlight assembly comprising:
a receiving container;
a fixing member disposed at side portion of the receiving container, the fixing member being electrically conductive; and
a plurality of cold cathode fluorescent lamps combined with the fixing member and positioned substantially in parallel with each other, each of the cold cathode fluorescent lamps including:
a lamp tube containing a discharge gas;
a fluorescent layer formed on an inner surface of the lamp tube;
an inner electrode disposed inside of the lamp tube;
a lead wire electrically connected to the inner electrode and extending to an exterior portion of the lamp tube; and
a conducting cap combined with the lamp tube, and electrically connected to the lead wire.

11. The backlight assembly of claim 10, wherein the conducting cap has a first diameter and a second diameter that is different from the first diameter.

12. The backlight assembly of claim 11, wherein the fixing member comprises a clip portion receiving the conducting cap of the cold cathode fluorescent lamp.

13. The backlight assembly of claim 12, wherein the conducting cap comprises:
a first cap portion covering an outer surface of the lamp tube, the first cap portion having the first diameter; and
a second cap portion covering an outer surface of the lead wire, the second cap portion having the second diameter.

14. The backlight assembly of claim 13, wherein the first cap portion is inserted into the clip portion of the fixing member.

15. The backlight assembly of claim 13, wherein the second cap portion is inserted into the clip portion of the fixing member.

16. The backlight assembly of claim 10, further comprising an electrically conductive adhesive between the lead wire and the conducting cap.

17. The backlight assembly of claim 10, further comprising:
an inverter that applies a driving voltage to the fixing member; and
an optical member disposed over the cold cathode fluorescent lamps.

18. The backlight assembly of claim 17, wherein the cold cathode fluorescent lamps are driven in parallel by the driving voltage provided by the inverter.

19. The backlight assembly of claim 17, wherein the optical member comprises:
a light diffusing plate that diffuses light generated by the cold cathode fluorescent lamps; and
an optical sheet disposed over the light diffusing plate.

20. The backlight assembly of claim 17, further comprising:
a first side mold disposed between the receiving container and the fixing member to fasten the fixing member to the receiving container; and
a second side mold covering the conducting cap and supporting the optical member.

21. A display apparatus comprising:
a backlight assembly including a receiving container, an electrically conductive fixing member disposed at side portion of the receiving container, and a plurality of cold cathode fluorescent lamps combined with the fixing member and positioned substantially in parallel with each other, and
a display unit displaying an image by using light provided by the backlight assembly, wherein each of the cold cathode fluorescent lamps includes:
a lamp tube containing a discharge gas;
a fluorescent layer formed on an inner surface of the lamp tube;
an inner electrode disposed inside of the lamp tube;
a lead wire that is electrically connected to the inner electrode and extending to an exterior portion of the lamp tube; and
a conducting cap combined with the lamp tube, and electrically connected to the lead wire.

22. The display apparatus of claim 21, wherein the conducting cap has a first diameter and a second diameter that is different from the first diameter.

23. The display apparatus of claim 21, wherein the fixing member comprises a clip portion receiving the conducting cap of the cold cathode fluorescent lamp.

24. The display apparatus of claim 21, further comprising an electrically conductive adhesive between the lead wire and the conducting cap.

25. The display apparatus of claim 21, wherein the display unit comprises:
a liquid crystal display panel displaying an image; and
a driving circuit section that drives the liquid crystal display panel.

26. The display apparatus of claim 21, wherein the backlight assembly further comprises an inverter that applies a driving voltage to the fixing member to drive the cold cathode fluorescent lamps in parallel.
